(19) United States
(12) Patent Application Publication
(10) Pub. No.: US 2020/0009686 A1
(43) Pub. Date: Jan. 9, 2020

(54) LASER WELDING METHOD

(71) Applicant: TOYOTA JIDOSHA KABUSHIKI KAISHA, Toyota-shi (JP)

(72) Inventors: Shuhei Ogura, Nagakute-shi (JP); Hiroki Sugino, Toyota-shi (JP); Ryuta Matsuo, Aichi-gun (JP); Ryosuke Kawai, Okazaki-shi (JP); Kazuho Takishita, Okazaki-shi (JP)

(73) Assignee: TOYOTA JIDOSHA KABUSHIKI KAISHA, Toyota-shi (JP)

(21) Appl. No.: 16/408,544

(22) Filed: May 10, 2019

(30) Foreign Application Priority Data
Jul. 3, 2018 (JP) 2018-126546

(51) Int. Cl. B23K 26/32; B23K 26/06; B23K 26/062; B23K 26/211; B23K 26/244; B23K 31/00

(52) U.S. Cl. CPC B23K 26/32; B23K 26/0608; B23K 31/003; B23K 26/211; B23K 26/244; B23K 26/062

(57) ABSTRACT

Provided is a laser welding method for performing lap welding on a plurality of laminated metal plates by applying a laser beam to the metal plates. The metal plates are constituted by n pieces of metal plates laminated in order from a first metal plate to an n-th metal plate, n being an integer not less than 2. The laser welding method includes: forming a recess serving as an escape route for gas by applying a first laser beam from the first metal plate side, the escape route penetrating through the first metal plate to an (n−1)th metal plate in the laminating direction to reach the n-th metal plate; and forming a welding pool around the recess so as to maintain the shape of the recess, the welding pool being formed by applying a second laser beam to the outside of the recess.

### INCORPORATION BY REFERENCE

The disclosure of Japanese Patent Application No. 2018-126546 filed on Jul. 3, 2018 including the specification, drawings and abstract is incorporated herein by reference in its entirety.

### BACKGROUND

### 1. Technical Field

The disclosure relates to a laser welding method for performing lap welding on a plurality of laminated metal plates by applying a laser beam to the metal plates.

### 2. Description of Related Art

In the related art, there has been known a laser welding method in which a plurality of laminated metal plates is irradiated with a laser beam so that a welding pool is formed over the metal plates, and the laminated metal plates are joined to each other by a welded portion formed by solidifying the welding pool.

There is such a case where the metal plates are welded when the metal plates include a metal plate on which a metal plating layer is formed or a casting plate, in other words, when the metal plates include a metal plate that generates gas such as a vapor of the metal plating layer (plating vapor) or hydrogen gas when the metal plate melts. In such a case, when no gap is provided between the metal plates, the gas generated at the time of welding might not be relieved sufficiently, thereby resulting in that plating vapor might blow off molten metal or hydrogen gas might remain in the welded portion and cause blowholes.

In order to solve such problems, Japanese Unexamined Patent Application Publication No. 2012-115876 (JP 2012-115876 A), for example, describes a laser welding method for joining galvanized steel plates put on top of one another. In the laser welding method, the steel plates are melted and a plating layer is vaporized by a first laser application, zinc vapor is gathered in the central part of a melting portion by second and third laser applications, and the zinc vapor thus collected is stirred and removed by fourth and fifth laser applications.

### SUMMARY

However, in JP 2012-115876 A, in a case where an amount of zinc vapor (an amount of plating vapor) is large, when the plating vapor is gathered in the central part of the melting portion, the plating vapor might expand and blow off the melting portion, and this might cause poor welding. Particularly, in a case of non-penetration welding in which a metal plate placed on the side opposite from a laser application side is not penetrated, the plating vapor easily stays in the melting portion, and therefore, such poor welding easily occur.

Further, in a case of a casting plate such as aluminum die-casting, a large amount of hydrogen gas dissolved in the casting plate at the time of casting is precipitated as air bubbles when the casting plate is melted by application of a laser beam. Accordingly, only by gathering and stirring gas in the central part as described in JP 2012-115876 A, such a case is assumed that hydrogen gas is not relieved sufficiently, and the hydrogen gas that is not discharged until the melting portion solidifies remains in the welded portion as blowholes.

The disclosure relates to a laser welding method for performing lap welding on a plurality of laminated metal plates and provides a technique to relieve generated gas and perform high-quality welding without being influenced by an amount of gas generated at the time of welding.

In the laser welding method of the disclosure, an escape route for gas to be generated when the metal plates are melted is secured before a welding pool is formed over the metal plates.

More specifically, a first aspect of the disclosure relates to a laser welding method for performing lap welding on a plurality of laminated metal plates by applying a laser beam to the metal plates.

In the laser welding method, the metal plates are constituted by n pieces of metal plates including at least one metal plate that generates gas due to melting, the metal plates being laminated in order from a first metal plate to an n-th metal plate, n being an integer not less than 2. The laser welding method includes: forming a recess serving as an escape route for the gas by applying a first laser beam from the first metal plate side, the escape route penetrating through the first metal plate to an (n−1)th metal plate in a laminating direction to reach the n-th metal plate; and forming a welding pool around the recess in the metal plates so as to maintain a shape of the recess, the welding pool being formed by applying a second laser beam to an outside of the recess.

Note that “to reach the n-th metal plate” in the disclosure means that the recess is formed in at least a part of the n-th metal plate. Accordingly, the recess may penetrate through the n-th metal plate or may not penetrate through the n-th metal plate.

In this configuration, after the recess is formed to penetrate through the first metal plate to the (n−1)th metal plate in the laminating direction and reach the n-th metal plate, the welding pool is formed around the recess such that the shape of the recess is maintained. Accordingly, even in a case where a large amount of gas is generated due to melting of the metal plates, the gas in the welding pool can be relieved to the outside via the recess, thereby making it possible to perform high-quality welding.

Further, in the laser welding method, the metal plate that generates the gas due to melting may be a metal plate on which a metal plating layer having a melting point lower than that of a base material is formed. The gas may be a vapor of the metal plating layer (plating vapor).

In this configuration, even in a case where a large amount of plating vapor is generated in non-penetration welding in which plating vapor easily stays inside the welding pool, for example, the welding pool can be formed while the plating vapor is relieved to the outside via the recess. Accordingly, it is possible to restrain the plating vapor from expanding and blowing off molten metal, thereby making it possible to restrain occurrence of poor welding.

Further, in the laser welding method, the metal plate that generates the gas due to melting may be a casting plate. The gas may be hydrogen gas dissolved in the casting plate at the time of casting.

With this configuration, even in a case where a large amount of hydrogen gas dissolved in the casting plate at the time of casting is precipitated when the casting plate is melted, the welding pool can be formed while the hydrogen gas is relieved to the outside via the recess, thereby making it possible to restrain blowholes from being formed in a welded portion obtained by solidifying the welding pool.

Further, the laser welding method may further include filling the recess with molten metal by applying a third laser beam to the welding pool after the welding pool is formed.

As the melting of the metal plates progresses in the forming of the welding pool, the recess might be finally filled up. However, the recess might remain in some cases. In this configuration, the remaining recess is filled with the molten metal by the application of the third laser beam. Accordingly, a surface of the welded portion obtained by solidifying the welding pool can be formed in a smooth shape.

Further, in the laser welding method, a position of a focus of the second laser beam in the laminating direction may be deeper than a position of a focus of the first laser beam in the laminating direction.

In this configuration, the second laser beam applied such that the position of its focus in the laminating direction is deeper than the position of the focus of the first laser beam in the laminating direction, in other words, the second laser beam applied with a relatively high energy density is applied around the recess, so that a part, around the recess, in a metal plate far from the laser application side, e.g., the n-th metal plate or the like, can be melted by high heat input.

As described above, with the laser welding method of the disclosure, it is possible to relieve generated gas and perform high-quality welding without being influenced by an amount of gas generated at the time of welding.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view schematically illustrating a welding structure formed by a laser welding method according to Embodiment 1 of the disclosure;

FIG. 2A is a schematic configuration diagram schematically illustrating a laser welding device configured to perform a laser welding method;

FIG. 2B is a schematic configuration diagram schematically illustrating the laser welding device configured to perform the laser welding method;

FIG. 3A is a view to schematically describe a recess forming step in the laser welding method;

FIG. 3B is a view to schematically describe a fusing step in the laser welding method;

FIG. 3C is a view to schematically describe a filling step in the laser welding method;

FIG. 4A is a view to schematically describe the recess forming step;

FIG. 4B is a view to schematically describe the recess forming step;

FIG. 5A is a view to schematically describe the fusing step;

FIG. 5B is a view to schematically describe the fusing step;

FIG. 5C is a view to schematically describe the fusing step;

FIG. 5D is a view to schematically describe the fusing step;

FIG. 6 is a perspective view to schematically describe the fusing step.

FIG. 7A is a view to schematically describe the filling step;

FIG. 7B is a view to schematically describe the filling step;

FIG. 8 is a view schematically illustrating a set example of welded materials;

FIG. 9 is a sectional view schematically illustrating a welding structure formed by a laser welding method according to Embodiment 2 of the disclosure;

FIG. 10A is a view to schematically describe a recess forming step in the laser welding method;

FIG. 10B is a view to schematically describe a fusing step in the laser welding method;

FIG. 10C is a view to schematically describe a filling step in the laser welding method;

FIG. 11 is a view schematically illustrating a test result of a shearing tension test;

FIG. 12A is a view to schematically describe a laser welding method in the related art;

FIG. 12B is a view to schematically describe the laser welding method in the related art;

FIG. 13A is a view to schematically describe a laser welding method in the related art; and

FIG. 13B is a view to schematically describe the laser welding method in the related art.

### DETAILED DESCRIPTION OF EMBODIMENTS

With reference to the drawings, the following describes embodiments to carry out the disclosure.

### Embodiment 1

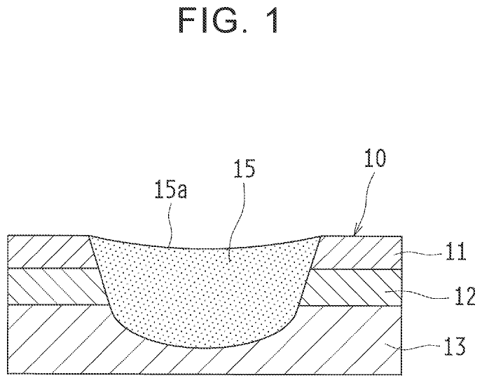

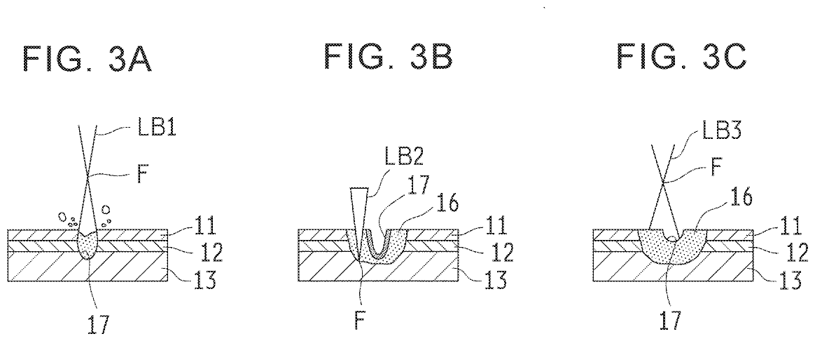

FIG. 1 is a sectional view schematically illustrating a welding structure 10 formed by a laser welding method according to the present embodiment. The welding structure 10 is configured such that first to third steel plates 11, 12, 13 that are laminated are irradiated with a laser beam LB from the first steel plate 11 side, so that a welding pool 16 (see FIGS. 3A to 3C) is formed over the first to third steel plates 11, 12, 13, and the first to third steel plates 11, 12, 13 thus laminated are joined by a welded portion 15 obtained by solidifying the welding pool 16. In the present embodiment, the first steel plate (a first metal plate) 11, the second steel plate (a second metal plate) 12, and the third steel plate (a third metal plate) 13 are each constituted by a galvanized steel plate.

Here, in a case where the galvanized steel plate is melted, when zinc vapor is generated, the zinc vapor is hard to be relieved because the welding structure 10 is configured such that the welded portion 15 does not penetrate through the third steel plate 13 (the welding structure 10 is formed by non-penetration welding). However, in the welding structure 10, the high-quality welded portion 15 is formed without poor welding, though no gap through which the zinc vapor is relieved is provided between the first steel plate 11 and the second steel plate 12 and between the second steel plate 12 and the third steel plate 13. The following more specifically describes the laser welding method of the present embodiment that enables formation of the welding structure 10 without poor welding.

Laser Welding Device

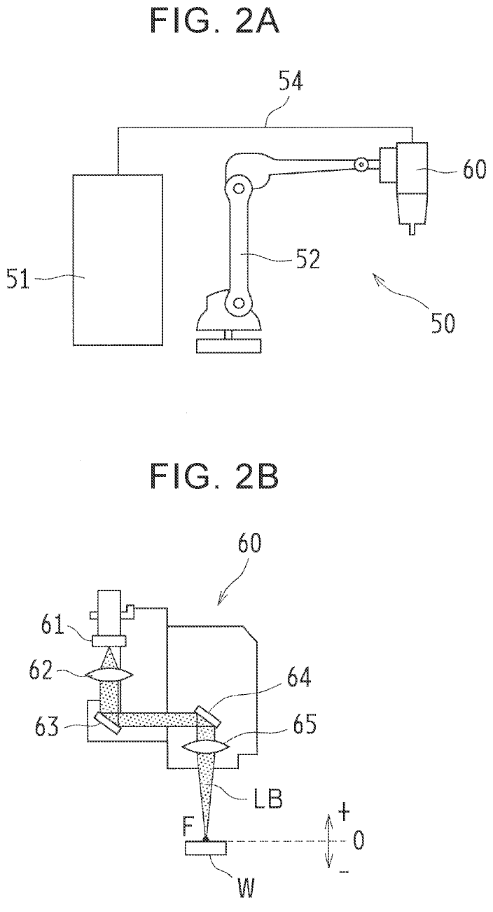

FIGS. 2A, 2B are schematic configuration diagrams schematically illustrating a laser welding device 50 configured to perform the laser welding method of the present embodiment. The laser welding device 50 is configured as a remote laser that performs laser welding by emitting a laser beam LB at a position away from a workpiece W. As illustrated in FIG. 2A, the laser welding device 50 includes a laser oscillator 51 configured to output the laser beam LB, a robot 52, and a 3D-scanner 60 configured to perform scanning with the laser beam LB supplied from the laser oscillator 51 via a fiber cable 54 such that the workpiece W is irradiated with the laser beam LB. The robot 52 is an articulated robot having a plurality of joints driven by a plurality of servomotors (not shown) and is configured to move the 3D-scanner 60 attached to a distal end of the robot 52 based on a command of a control device (not shown).

As illustrated in FIG. 2B, the 3D-scanner 60 includes a sensor 61, a condensing lens 62, a fixed mirror 63, a movable mirror 64, and a convergent lens 65. The laser beam LB supplied from the laser oscillator 51 to the 3D-scanner 60 is emitted from the sensor 61 to the condensing lens 62. After the laser beam LB is collected by the condensing lens 62, the laser beam LB is reflected back toward the movable mirror 64 by the fixed mirror 63. After the direction of the laser beam LB is changed by the movable mirror 64, the laser beam LB is directed toward the workpiece W so as to have a predetermined spot diameter via the convergent lens 65. With such a configuration, in the laser welding device 50 of the present embodiment, when the movable mirror 64 is driven based on the command from the control device (not shown), the laser beam LB can be applied to a predetermined position within a range of a 200-mm square in a state where the laser welding device 50 is distanced from the workpiece W by 500 mm, for example.

The condensing lens 62 is configured to be movable in the up-down direction by an actuator (not shown), and by moving the condensing lens 62 in the up-down direction, its focal distance is adjusted in the up-down direction. Therefore, in the laser welding device 50 of the present embodiment, in a case where the top face of the workpiece W is assumed as a base (0), when a focus F is shifted to a “+” side or a “−” side, a defocus state or an in-focus state is easily achievable.

Laser Welding Method

Next will be described the laser welding method of the present embodiment using the laser welding device 50. However, prior to this, the following will first describe a laser welding method in the related art in a case where lap welding is performed on a plurality of metal plates including a galvanized steel plate, for easy understanding of the disclosure.

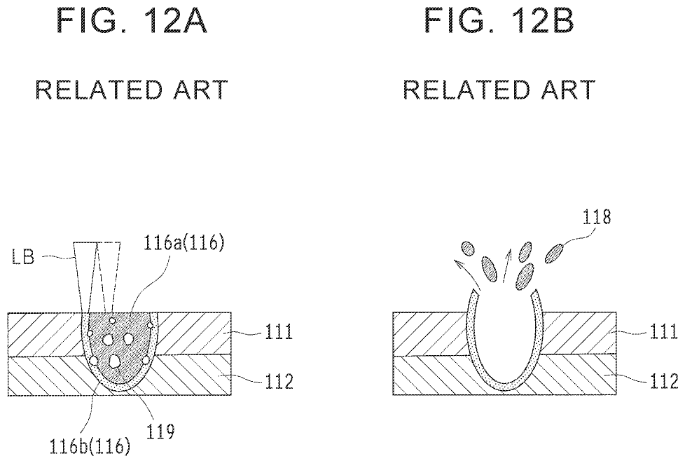

FIGS. 12A, 12B are views to schematically describe the laser welding method in the related art. In the laser welding method in the related art, as illustrated in FIG. 12A, when a first steel plate 111 and a second steel plate 112 as galvanized steel plates are irradiated with the laser beam LB, a welding pool 116a is formed to penetrate through the first steel plate 111 in the laminating direction and reach the second steel plate 112. For example, the laser beam LB is applied with scanning being performed to draw a circle, so as to enlarge the welding pool 116 (a welding pool 116b is formed outside a welding pool 116a).

As such, as the laser beam LB is applied to enlarge the welding pool 116, zinc plating having a melting point lower than a base material (the steel plate) is sublimated, so that an amount of zinc vapor inside the welding pool 116 increases. In a case where non-penetration welding in which the second steel plate 112 is not penetrated is performed and no gap is provided between the first steel plate 111 and the second steel plate 112, there is no escape route for generated zinc vapor 119, and the zinc vapor 119 remains inside the welding pool 116. On this account, in a case where a large amount of zinc vapor 119 is generated, the zinc vapor 119 pops (expands) and blows off the molten metal 118, as illustrated in FIG. 12B, thereby causing such a possibility that poor welding occurs (a welded portion is not formed).

In view of this, in the laser welding method of the present embodiment, before the welding pool 16 is formed in the first to third steel plates 11, 12, 13, an escape route for zinc vapor (plating vapor) to be generated when the first to third steel plates 11, 12, 13 are melted is secured.

More specifically, the laser welding method of the present embodiment includes: a recess forming step of forming a recess 17 serving as an escape route for zinc vapor by applying a first laser beam LB1 from the first steel plate 11 side, as illustrated in FIG. 3A, the escape route penetrating through the first and second steel plates 11, 12 in the laminating direction to reach the third steel plate 13; a fusing step of applying a second laser beam LB2 to the outside of the recess 17 so as to form the welding pool 16 around the recess 17 in the first to third steel plates 11, 12, 13, as illustrated in FIG. 3B, such that the shape of the recess 17 is maintained; and a filling step of filling the recess 17 with molten metal by applying a third laser beam LB3 to the welding pool 16 as illustrated in FIG. 3C. Hereinafter, these steps will be described in detail. For purposes of this description, the first steel plate 11 side in the laminating direction is assumed as the upper side, and the third steel plate 13 side in the laminating direction is assumed as the lower side.

Recess Forming Step

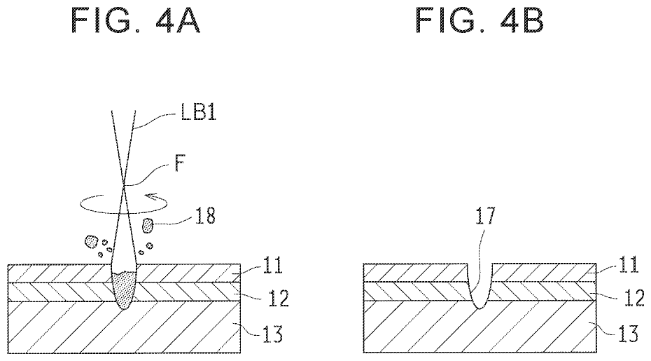

FIGS. 4A, 4B are views to schematically describe the recess forming step. In the recess forming step, by applying the first laser beam LB1 to a relatively small range from the first steel plate 11 side, a molten metal 18 in an application range and its surrounding zinc plating are scattered by a spatter as illustrated in FIG. 4A, so that the recess 17 is formed to penetrate through the first and second steel plates 11, 12 in the laminating direction and reach the third steel plate 13, as illustrated in FIG. 4B.

In the recess forming step, in order to form the recess 17 quickly without taking time, the first laser beam LB1 with a relatively high output is applied once (the number of emission times is one).

However, when the first laser beam LB1 with a relatively high output is applied in a high energy density state, energy of blowing off the molten metal 18 by the spatter becomes too strong, and the molten metal 18 blown off upward might hit the laser welding device 50 and damage the laser welding device 50. On this account, as illustrated in FIG. 4A, the first laser beam LB1 is applied in a defocus state where its focus F is placed above the first steel plate 11.

Further, in the recess forming step, the recess 17 is formed in a relatively small range, so that a scanning speed V1 of the first laser beam LB1 with which scanning is performed to draw a circle may be relatively low. Besides, the first laser beam LB1 may not necessarily be applied while scanning is performed to draw a circle, and the first laser beam LB1 may be applied in a state where its movement is stopped.

Note that, the output, the number of emission times, the laser focus position in the laminating direction, and the scanning speed as described above are just examples, and the first laser beam LB1 may be applied under other conditions, provided that the recess 17 can be formed to penetrate through the first and second steel plates 11, 12 in the laminating direction and reach the third steel plate 13.

Fusing Step

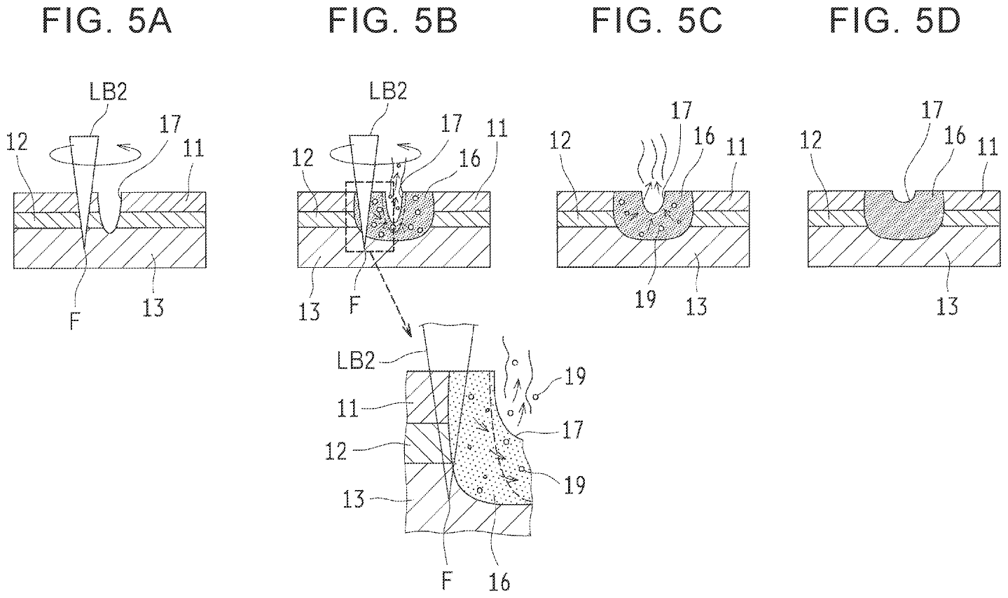

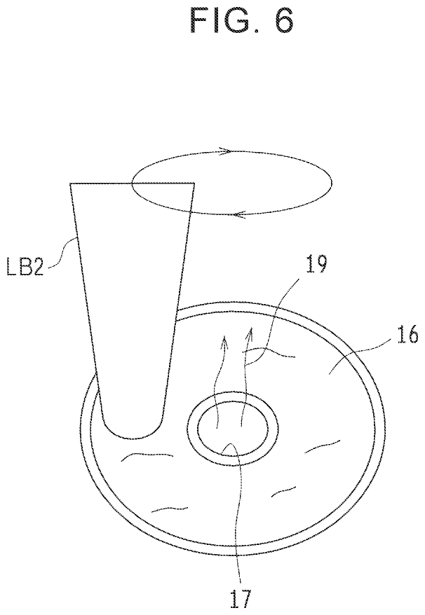

FIGS. 5A to 5D are views to schematically describe the fusing step, and FIG. 6 is a perspective view to schematically describe the fusing step. In the fusing step, the second laser beam LB2 is applied to a wide range to target the outside of the recess 17 formed in the recess forming step, as illustrated in FIG. 5A, so that the welding pool 16 is formed around the recess 17 in the first to third steel plates 11, 12, 13 as illustrated in FIG. 5B.

At this time, if the laser beam LB is applied with a relatively high output, all the molten metal might be blown off in some cases. Accordingly, in the fusing step, the second laser beam LB2 with a relatively low output is applied. In order to surely melt the second and third steel plates 12, 13, the second laser beam LB2 is applied in an in-focus state where its focus F reaches the third steel plate 13, as illustrated in FIGS. 5A and 5B. As such, by placing the position of the focus F of the second laser beam LB2 in the laminating direction more deeply than the position of the focus F of the first laser beam LB1 in the laminating direction, heat input into the second and third steel plates 12, 13 is made high, so that a base material below the recess 17 can be surely melted.

Further, in the fusing step, the welding pool 16 is formed around the recess 17 in the first to third steel plates 11, 12, 13 such that the shape of the recess 17 is maintained as illustrated in FIGS. 5B and 6. At this time, the second laser beam LB2 is applied to the outside of the recess 17 such that scanning is performed to draw a circle. However, it is important to relieve generated zinc vapor 19 to the outside via the recess 17 while the welding pool 16 is formed, and it is not necessary to stir the welding pool 16. Accordingly, a scanning speed V2 of the second laser beam LB2 may not be relatively high. However, in a case where the scanning speed V2 of the second laser beam LB2 is too slow, such a case is assumed that a hole is formed in a part irradiated with the second laser beam LB2. Therefore, in a case where a scanning speed V3 of the third laser beam LB3 (described later) is relatively high, it is preferable that the scanning speed V2 of the second laser beam LB2 be set to an intermediate speed that satisfies V1<V2<V3.

Note that the number of heat-input times of the second laser beam LB2 may be one time or several times. For example, when the zinc vapor 19 is relieved from the recess 17 and a desired welding pool 16 is formed by applying the second laser beam LB2 once around the recess 17 at an intermediate speed, the number of heat-input times may be one time, or for example, when the welding pool 16 is enlarged by applying the second laser beam LB2 around the recess 17 several times to secure a desired joining strength, the number of heat-input times may be several times.

As such, by applying the second laser beam LB2 to the outside of the recess 17 in an in-focus state so as to maintain the shape of the recess 17, the zinc vapor 19 generated in the course of forming and enlarging the welding pool 16 gathers in the center of the welding pool 16, and the zinc vapor 19 is discharged to the outside via the recess 17 while the recess 17 is filled with molten metal flowing therein from the bottom side where the heat input is high, as illustrated in the enlarged view of FIG. 5B.

Then, after the application of the second laser beam LB2 is finished, the molten metal constituting the welding pool 16 flows into the recess 17 at a stretch from the bottom side of the recess 17, so that the zinc vapor 19 is discharged to the outside while the recess 17 is filled with the molten metal from the bottom side, as illustrated in FIG. 5C. Hereby, as illustrated in FIG. 5D, a small recess 17 remains in the welding pool 16 from which the zinc vapor 19 is discharged, but in some cases, the recess 17 might be naturally filled up with the molten metal.

Note that, the output, the laser focus position in the laminating direction, and the scanning speed as described above are just examples, and the second laser beam LB2 may be applied under other conditions, provided that the welding pool 16 can be formed around the recess 17 in the first to third steel plates 11, 12, 13 such that the shape of the recess 17 is maintained.

Filling Step

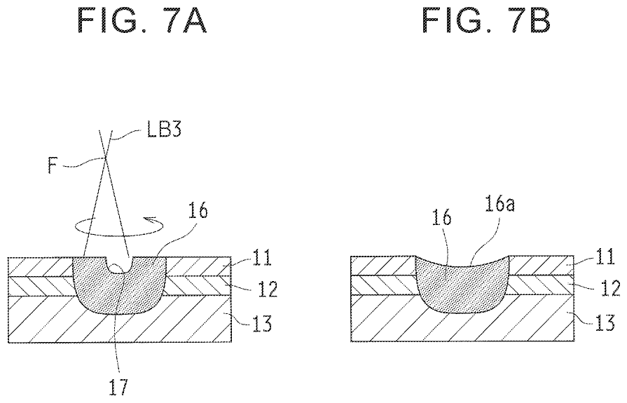

FIGS. 7A, 7B are views to schematically describe the filling step. In the filling step, the recess 17 is filled with the molten metal by applying the third laser beam LB3 to the welding pool 16 within a range where the recess 17 is to be filled up as illustrated in FIG. 7A, and the molten metal is solidified such that a surface 16a of the welding pool 16 to become the welded portion 15 is smoothed as illustrated in FIG. 7B. Note that, as described above, when the recess 17 is filled up naturally in the fusing step, the filling step can be omitted.

In the filling step, when the laser beam LB is applied with a relatively high output, all the welding pool 16 might be blown off in some cases. Accordingly, the third laser beam LB3 with a relatively low output is applied once or several times (the number of emission times is one to several times). Further, for the same reasons, the third laser beam LB3 is applied in a defocus state where its focus F is placed above the first steel plate 11 as illustrated in FIG. 7A.

Further, in the filling step, in order to smooth the surface 16a of the welding pool 16 without taking time, the scanning speed V3 of the third laser beam LB3 with which scanning is performed to draw a circle is set to be relatively high so that the welding pool 16 is stirred.

Note that the output, the number of emission times, the laser focus position in the laminating direction, and the scanning speed as described above are just examples, and the third laser beam LB3 may be applied under other conditions, provided that the remaining recess 17 can be filled up.

As described above, in the laser welding method of the present embodiment, the recess 17 is formed by the application of the first laser beam LB1 such that the recess 17 penetrates through the first and second steel plates 11, 12 in the laminating direction and reaches the third steel plate 13, and the welding pool 16 is formed around the recess 17 by the application of the second laser beam LB2 such that the shape of the recess 17 is maintained. Accordingly, even in a case where the amount of the zinc vapor 19 generated by melting of the first to third steel plates 11, 12, 13 is large, the zinc vapor 19 thus generated can be relieved to the outside via the recess 17. Therefore, even in a case where a large amount of the zinc vapor 19 is generated, it is possible to restrain the zinc vapor 19 from popping (expanding) and blowing off the molten metal, thereby making it possible to restrain occurrence of poor welding.

Further, since the remaining recess 17 is filled with the molten metal by the application of the third laser beam LB3, the surface 15a of the welded portion 15 obtained by solidifying the welding pool 16 can be formed in a smooth shape.

Further, the second laser beam LB2 applied such that the position of its focus F in the laminating direction is deeper than the position of the focus F of the first laser beam LB1 in the laminating direction, in other words, the second laser beam LB2 applied with a relatively high energy density is applied to the outside of the recess 17, so that parts, around the recess 17, in the second and third steel plates 12, 13 can be melted by high heat input.

### Example 1

Next will be described an example of an experiment performed to check the effect of the laser welding method of the present embodiment.

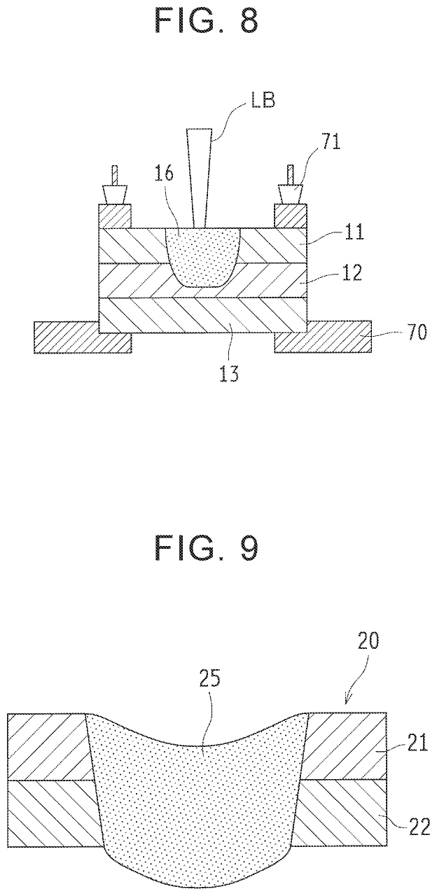

In Example 1, a galvanized steel plate having a thickness of 0.6 mm was prepared as the first steel plate 11, a galvanized steel plate having a thickness of 0.7 mm was prepared as the second steel plate 12, and a galvanized steel plate having a thickness of 1.8 mm was prepared as the third steel plate 13. These galvanized steel plates were laminated in order of the first to third steel plates 11, 12, 13 and subjected to the laser welding method using the laser welding device 50. More specifically, in order to perform the laser welding method under more disadvantageous conditions, non-penetration welding was performed in a round welding pattern by setting a gap between the steel plates to 0 (mm) so as to eliminate an escape route for zinc vapor. Note that the setting of the gap to 0 (mm) was achieved in such a manner that the first to third steel plates 11, 12, 13 placed on a jig 70 were pressed by a clamp 71 as illustrated in FIG. 8.

As a result of such an experiment, it was found that the welding structure 10 having the high-quality welded portion 15 as illustrated in FIG. 1 was formed without expanding zinc vapor to blow off molten metal in the course of welding.

### Embodiment 2

The present embodiment is different from Embodiment 1 in that a welding structure 20 is constituted by aluminum die-casting plates 21, 22. The following mainly describes points different from Embodiment 1.

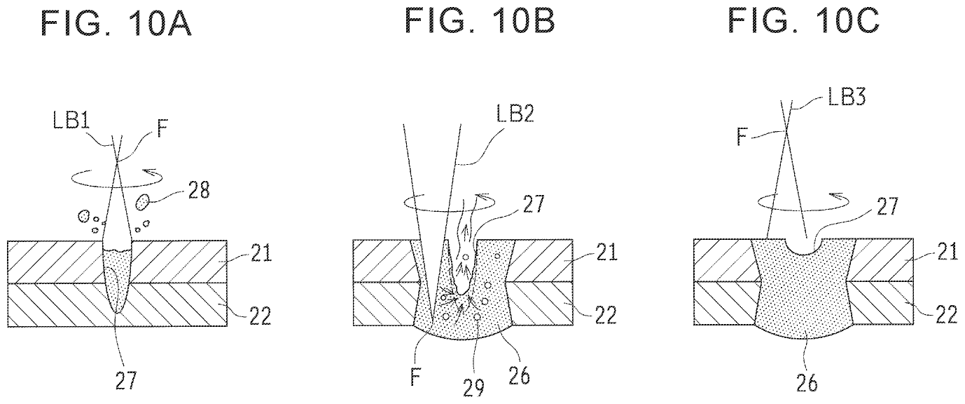

FIG. 9 is a sectional view schematically illustrating the welding structure 20 formed by a laser welding method according to the present embodiment. The welding structure 20 is configured such that the first and second aluminum die-casting plates 21, 22 that are laminated are irradiated with the laser beam LB, so that a welding pool 26 (see FIGS. 10A to 10C) is formed over the first and second aluminum die-casting plates 21, 22, and the first and second aluminum die-casting plates 21, 22 thus laminated are joined by a welded portion 25 obtained by solidifying the welding pool 26.

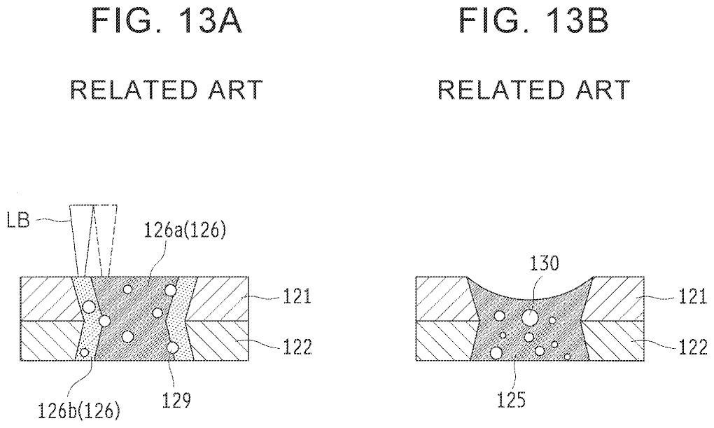

FIGS. 13A, 13B are views to schematically describe a laser welding method in the related art. In the laser welding method in the related art, a welding pool 126a penetrating through first and second aluminum die-casting plates 121, 122 in the laminating direction is formed by applying the laser beam LB to the first and second aluminum die-casting plates 121, 122 as illustrated in FIG. 13A, and the laser beam LB is applied with scanning being performed to draw a circle, for example, thereby enlarging a welding pool 126 (a welding pool 126b is formed outside the welding pool 126a).

As such, as the laser beam LB is applied to enlarge the welding pool 126, a large amount of hydrogen gas 129 dissolved in the first and second aluminum die-casting plates 121, 122 at the time of casting is precipitated as air bubbles. Then, air bubbles (the hydrogen gas 129) that are not discharged until the welding pool 126 is solidified remain in a welded portion 125 as blowholes 130, as illustrated in FIG. 13B, so that the strength of the welded portion 125 varies in accordance with the number of blowholes 130.

In view of this, in the laser welding method of the present embodiment, prior to forming the welding pool 26 in the first and second aluminum die-casting plates 21, 22, an escape route for hydrogen gas 29 to be precipitated when the first and second aluminum die-casting plates 21, 22 are melted is secured, similarly to Embodiment 1.

More specifically, the laser welding method of the present embodiment includes: a recess forming step of forming a recess 27 serving as an escape route for the hydrogen gas 29 by applying the first laser beam LB1 from the first aluminum die-casting plate 21 side to blow off a molten metal 28, as illustrated in FIG. 10A, the recess 27 penetrating through the first and second aluminum die-casting plates 21, 22 in the laminating direction; a fusing step of applying the second laser beam LB2 to the outside of the recess 27 so that the welding pool 26 is formed around the recess 27 in the first and second aluminum die-casting plates 21, 22 so as to maintain the shape of the recess 27 and the hydrogen gas 29 is relieved to the outside via the recess 27 as illustrated in FIG. 10B; and a filling step of filling the recess 27 with molten metal by applying the third laser beam LB3 to the welding pool 26 as illustrated in FIG. 10C.

Hereby, even in a case where a large amount of the hydrogen gas 29 dissolved in the first and second aluminum die-casting plates 21, 22 at the time of casting is precipitated as air bubbles when the first and second aluminum die-casting plates 21, 22 are melted, the welding pool 26 can be formed while the hydrogen gas 29 thus precipitated is relieved to the outside via the recess 27. Hereby, it is possible to restrain blowholes from being formed in the welded portion 25 obtained by solidifying the welding pool 26.

### Example 2

Next will be described an example of an experiment performed to check the effect of the laser welding method of the present embodiment.

In the example, an aluminum die-casting plate having a thickness of 2.5 mm was prepared as the first aluminum die-casting plate 21, and an aluminum die-casting plate having a thickness of 2.5 mm was prepared as the second aluminum die-casting plate 22. These aluminum die-casting plates were laminated in order of the first and second aluminum die-casting plates 21, 22 and subjected to the laser welding method using the laser welding device 50. More specifically, in order to perform the laser welding method under more disadvantageous conditions, penetration welding was performed in a round welding pattern by setting a gap between the aluminum die-casting plates to 0 (mm) so as to eliminate an escape route for hydrogen gas, as the present example. Note that, similarly to FIG. 8, the setting of the gap to 0 (mm) was achieved in such a manner that the first and second aluminum die-casting plates 21, 22 placed on the jig 70 were pressed by the clamp 71.

Further, as a comparative example, the first and second aluminum die-casting plates 121, 122 having a thickness of 2.5 mm were laminated and subjected to the laser welding method in the related art.

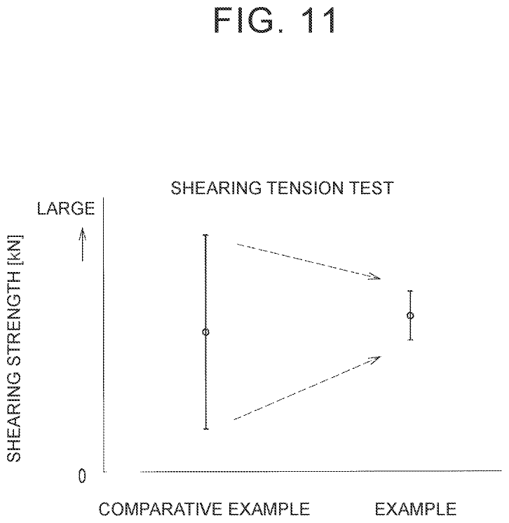

Results of shearing tension tests performed on the comparative example and the present example are illustrated in FIG. 11. As is apparent from FIG. 11, in the present example, it was found that a variation in shearing tensile strength was reduced in comparison with the comparative example, in other words, it was found that occurrence of blowholes in the welded portion 25 was restrained and stable strength was obtained in comparison with the comparative example.

### Other Embodiments

The disclosure is not limited to the above embodiments and can be carried out in other various forms without departing from the spirit or main feature of the disclosure.

In the above embodiments, the disclosure is applied to the first to third steel plates 11, 12, 13 and to the first and second aluminum die-casting plates 21, 22 laminated without any gap. However, the disclosure is not limited to this, and the disclosure may be applied to a plurality of metal plates laminated with a gap.

Further, in the above embodiments, the recesses 17, 27 do not penetrate. However, the disclosure is not limited to this, and the recesses 17, 27 may penetrate through the third steel plate 13 and the second aluminum die-casting plate 22.

In Embodiment 1, the first to third steel plates 11, 12, 13 are each constituted by a galvanized steel plate, but the disclosure is not limited to this, provided that at least one of the first to third steel plates 11, 12, 13 is constituted by a galvanized steel plate, and the other steel plates may be constituted by other metal plates.

In Embodiment 2, the welding structure 20 is constituted by the first and second aluminum die-casting plates 21, 22, but the disclosure is not limited to this, and the welding structure may be constituted by an aluminum die-casting plate and another metal plate.

Thus, the above embodiments are just examples in every respect and must not be interpreted restrictively. Further, modifications and alterations belonging to an equivalent range of Claims are all included in the disclosure.

### INDUSTRIAL APPLICABILITY

With the disclosure, it is possible to relieve generated gas and perform high-quality welding without being influenced by an amount of gas to be generated at the time of welding, so that the disclosure is extremely advantageous when the disclosure is applied to a laser welding method for performing lap welding on a plurality of laminated metal plates.

What is claimed is:

1. A laser welding method for performing lap welding on a plurality of laminated metal plates by applying a laser beam to the metal plates, the metal plates being constituted by n pieces of metal plates including at least one metal plate that generates gas due to melting, the metal plates being laminated in order from a first metal plate to an n-th metal plate, n being an integer not less than 2, the laser welding method comprising:
forming a recess serving as an escape route for the gas by applying a first laser beam from a first metal plate side, the escape route penetrating through the first metal plate to an (n−1)th metal plate in a laminating direction to reach the n-th metal plate; and
forming a welding pool around the recess in the metal plates so as to maintain a shape of the recess, the welding pool being formed by applying a second laser beam to an outside of the recess.

2. The laser welding method according to claim 1, wherein:
the metal plate that generates the gas due to melting is a metal plate on which a metal plating layer having a melting point lower than that of a base material is formed; and
the gas is a vapor of the metal plating layer.

3. The laser welding method according to claim 1, wherein:
the metal plate that generates the gas due to melting is a casting plate; and
the gas is hydrogen gas dissolved in the casting plate at a time of casting.

4. The laser welding method according to claim 1, further comprising filling the recess with molten metal by applying a third laser beam to the welding pool after the welding pool is formed.

5. The laser welding method according to claim 1, wherein a position of a focus of the second laser beam in the laminating direction is deeper than a position of a focus of the first laser beam in the laminating direction.
